(19) United States
(12) Patent Application Publication
(10) Pub. No.: US 2013/0157640 A1
(43) Pub. Date: Jun. 20, 2013

(54) Safe Vehicular Phone Usage

(71) Applicant: William Edward Aycock, Orlando, FL (US)

(72) Inventor: William Edward Aycock, Orlando, FL (US)

(21) Appl. No.: 13/544,126

(22) Filed: Jul. 9, 2012

Related U.S. Application Data
(60) Provisional application No. 61/508,339, filed on Jul. 15, 2011.

(51) Int. Cl. H04W 4/04

(52) U.S. Cl. CPC H04W 4/046
USPC 455/418

(57) ABSTRACT

The present invention discloses a system comprising a vehicular unit and a cellular phone application, which, after a series of digital security confirmations, communicate freely. Using the application to start the automobile notifies the phone that the cellular user is the driver. When this information is conveyed along with velocity information from the vehicular unit, the application will proceed to restrict access to the phone. As such, the phone will perform a predetermined number of actions ranging from complete cellular communication disablement to activation of a hands-free communication mode. Upon stopping the vehicle, full phone functionality will resume. The phone could also act as an interface with the vehicle allowing method for locking and unlocking doors, opening and closing windows, and engaging the vehicular alarm remotely.

### CROSS-REFERENCE TO RELATED APPLICATIONS

Previously filed Provisional Application No. 61/508,339 on Jul. 15^{th}, 2011.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The automobile has defined the default mode of transportation for society. An international infrastructure of roadways, bridges, tunnels, toll roads, and gas stations has been configured to allow and encourage road traffic as the primary means for traveling between destinations. The requirements for securing and maintaining a vehicular driver's license are minimal and allow for introduction to the automotive transportation system from an early age. The restrictions are loose enough that driver's licenses are often still held by members of society with ages above 80, and occasionally even 90 years of age. The cost and convenience of owning an automobile is such that most families own more than one vehicle, and oftentimes, households have a greater number of vehicles than family members. To say that the automobile has shaped and defined the travel landscape over the last century would be a true understatement.

More recently, cellular telephones have altered a variety of the hardships traditional associated with automobile travel. Before the availability of cell phones, people were forced to locate telephone booths or other means of making landline telephone calls while traveling. Lost drivers were also forced to refer to maps or ask for directions rather than referencing their cellular device. With the advent of the cellular phone, drivers can now maintain a constant connection with loved ones and with their businesses. The cellular phone has allowed for real time checking of email, social media updates, and sports scores. It has allowed for scheduling of events and for entertainment while traveling down a remote highway. With the adoption of cellular telephone service eclipsing that of traditional landline service, most drivers today own a cellular phone.

While cellular service has, in many ways, streamlined and improved the automotive travel experience, it has also created a new set of concerns. Scientific studies have proven that drivers who use cellular phones while driving have a decreased sense of awareness and a slowed reaction time. This has been shown to be true irrespective of whether or not the phone is being used in a “hands-free” configuration or whether the driver is physically holding the phone to their ear. While speaking on the phone does allow for the driver to continue a continuous visual connection with the vehicle surroundings, sending and receiving text messages (among other functions) require that the driver of the vehicle take their eyes off of the road and focus on the contents of the telephone screen. Scientific studies have shown that sending and receiving text messages while driving have a greater adverse effect on driving skills than driving while intoxicated.

In response to the concerns about maintaining safe control of a vehicle, many states have enacted laws that limit or completely ban cellular phone activities while driving. Unfortunately, due to the convenience and familiarity of both driving and using a cell phone, drivers often ignore the restrictions and laws, resulting in avoidable collisions and injuries.

Various products and patents have devised approaches to minimize the potential for cellular phone related vehicular incidences. U.S. Pat. No. 7,856,203 details a vehicular system which restricts the functionality of a cellular phone's keyboard. While this functionality is desirable, the system is very difficult to implement, requiring overcoming assorted accuracy concerns, and does not cover the broader scope of cellular applications that may endanger drivers. Similarly, U.S. patent application Ser. No. 13/025,017 discloses a method to trigger cellular phone deactivation through the use of a particularly identified physical car key provided by the original equipment manufacturer, focusing specifically on driver age as an action trigger. Patent application Ser. No. 11/115,038 discloses a method for using present motion verification technology to disable a cell phone, regardless of whether the phone operator is the driver of the vehicle. Patent application Ser. No. 12/802,008 uses a signal broadcasting system activated by the driver's door to deactivate cellular functionality.

In addition the above mentioned patent publications, there are a variety of commercially available cellular applications that allow for the immobilization of phone via a GPS motion confirmation and internal sensors contained on board the phone. None of these systems properly distinguish a vehicle driver from a vehicle passenger. In addition, these systems do not operate in cooperation with a specific automobile, creating possible usage issues if the phone is attempted to be used on commercial transportation, such as a commuter train or a public ferry.

### BRIEF SUMMARY OF THE INVENTION

The present invention aims to provide solutions to the various shortcomings of the prior art noted above. The present invention creates a system in which the automobile and the driver's cellular phone are acting in coordination to prevent duplicity and/or loop holes that allow for operation of unsafe cell phone functions while the vehicle is in motion. The system consists of an application installed on a cellular phone and a unit installed on the vehicle. The vehicular unit communicates with the cellular phone and allows for the cellular phone to serve as a key to lock and unlock the car and many other functions, but more importantly as means for remotely starting the vehicle. The act of starting the car is used to associate the phone as belonging to the driver. The phone will receive velocity data from the vehicle, which will, in turn, restrict access to various cell phone functions that may be detrimental to the safe operation of the vehicle.

Unlike the prior art inventions, the present invention provides a logical and easily implementable method for determining who the driver of the vehicle is. Because the car is started via communication with the cellular phone, the car can identify which phone is interfacing with the receiving unit. When the unit receives a signal from the phone to start the car, it will be able to properly determine that the owner of the cell phone sending the start request is the intended driver. This information is conveyed to the application on the phone, triggering a variety of optional actions. These actions can be based upon local laws or dictated by user preference. The actions can be as severe as completely disabling cellular communications or as mild as putting the phone into a hands-free mode allowing operation only voice operation. If the phone is equipped with a GPS receiver, upon car ignition, the phone can optionally query a remote database and determine the necessary phone settings in order to comply with local laws and regulations.

### BRIEF DESCRIPTION OF THE SEVERAL VIEWS OF THE DRAWINGS

FIG. 1. This figure shows the logical communication path for both the cellular handset and the vehicular unit. The process begins with initiation of an ignition request and is completed with the shutting off of the vehicle.

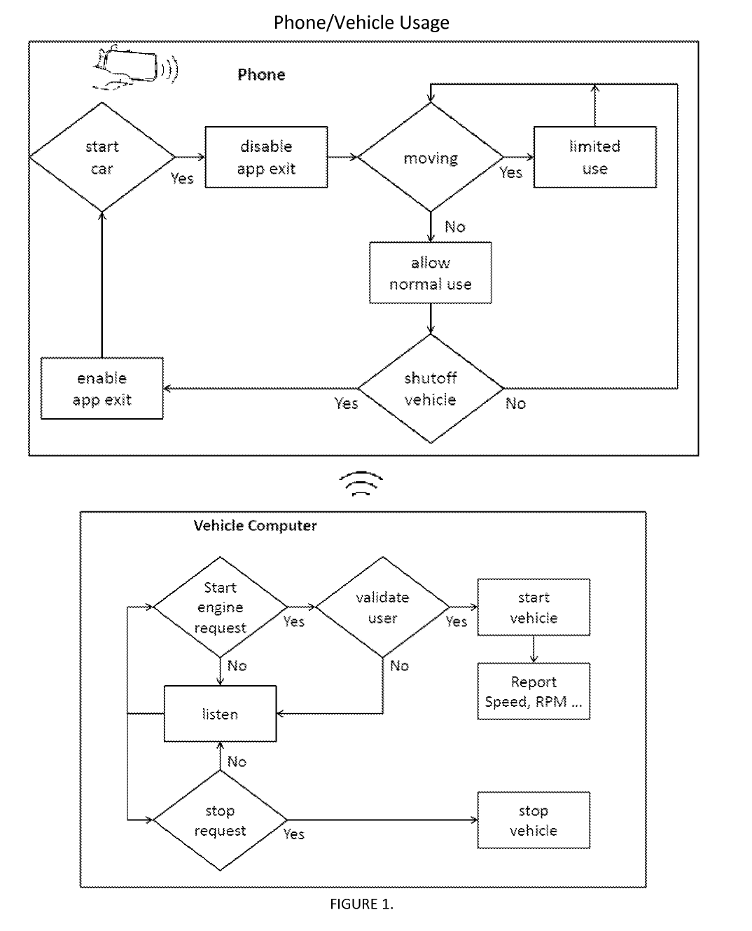

FIG. 2. This figure details the path involved in the manual usage of the system. This typically occurs when the use of a physical key is involved in the starting and shutting off of the vehicle.

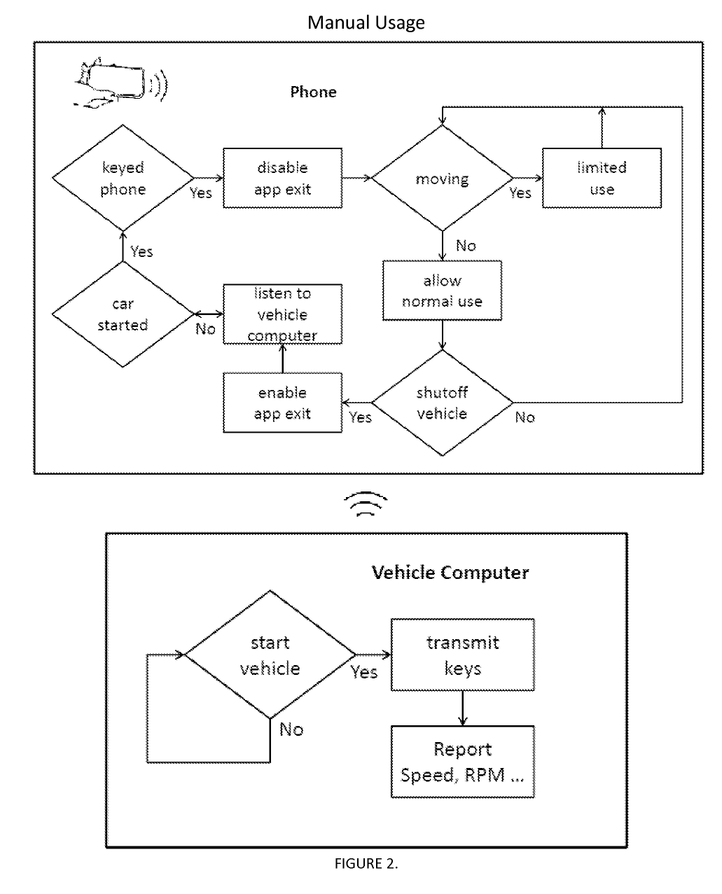

FIG. 3. This diagram depicts the login and initialization procedure to ensure secure communication and pairing of a cellular device and the vehicular unit.

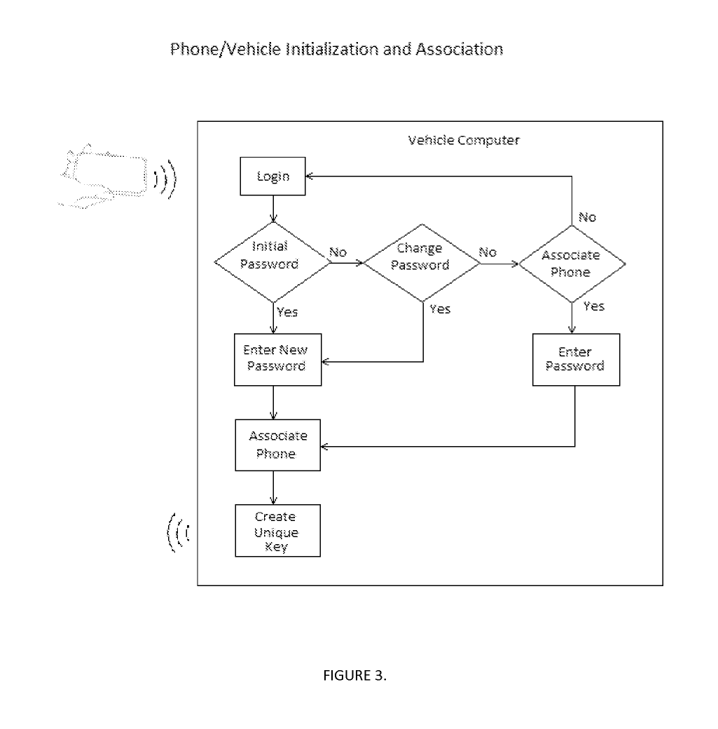

### DETAILED DESCRIPTION OF THE INVENTION

The detailed disclosure herein described is intended to disclose a preferred embodiment of the present invention. The present invention may have a variety of variations based upon the preferred embodiment. The present invention should not be limited to specific verbiage or examples given in the preferred embodiment as many variations can be constructed based upon the described scope and nature of the invention.

The rate of vehicular crashes and accidents increase drastically when the automobile driver becomes distracted. One of the greatest causes of distractions for present day drivers is stimuli from their cellular phones. It is the intent of the present invention to disclose a method for properly identifying the driver of the automobile and restricting access to all or a portion thereof of only the driver's cellular phone's feature set and functionality.

There are two primary concerns the present invention addresses. The first concern is to ensure that the driver of an automobile does not use a cellular communication device, such as a cell phone, in an illegal or inappropriate manner. The second concern addressed is to verify the identity of the automobile driver and only restrict the usage of this particular cell phone, irrespective of the functionality of the other cellular phones in the car. These concerns are addressed via the use of a two-part system, comprised of application installed on a cellular device and a communication/computer device installed in the vehicle. The vehicle computer could take advantage of current technology (such as the OBD-II) or any available future technology.

The cellular device's software consists of an application that is constantly running in the background of the unit's operating system. During “standby” operation, the software is checking for the presence of the vehicular data unit. If a unit is located, the application provides access to a variety of commands. The list of commands could include, but is not limited to: vehicle locking/unlocking, vehicle ignition starting/shutting off, window opening/closing, trunk opening/closing, power door opening/closing, and user setup and configuration options. The vehicle ignition start/stop commands must be implemented. In the absence of said unit, the cellular device functions and operates normally. However, if the cellular phone's application acknowledges the presence of the vehicular data unit, it begins a process to verify the user and restrict the phone usage accordingly. In the event that the application verifies that the cellular phone is not operated by the driver, functionality of the phone is not restricted and the software will revert back to “standby” operation.

The second component to the system is a communication unit installed into the automobile. The vehicle must be retrofitted to enable unit functionality, or, conversely, the unit can be installed as a part of the Original Equipment Manufacturer's (OEM) system, providing native functionality with the car. The vehicular data unit has the capability to communicate with the application on the phone. This communication can be done via Bluetooth, Wi-Fi, Radio Frequency (RF), or through any other wireless communication means. The vehicular data unit has the responsibility of verifying the authenticity of the user's cellular phone before providing the phone access to the various vehicular functions (such as locking/unlocking the doors, raising/lowering windows, starting the car, shutting off the car, etc.). In addition to serving as the gateway for cellular operation of various vehicular functions, it is also responsible for providing velocity feedback and engine state. The data can be provided in the form of a discrete value (moving or not moving, running or not running), in the form of actual velocity data and the engine RPM. While the preferred embodiment tasks the vehicular data unit with the logging of the system usage, variations could alternatively task the phone with tracking the system usage.

The system functionality is based on three principles.
1. The vehicle's ignition must be started via the cellular phone's software application.
2. This action, in turn, is used to identify the driver of the vehicle.
3. Lastly, a series of processes result in the phone being placed in a legal and/or safe mode.

The vehicle can only be started by a cellular phone whose software application has completed an authentication process with the vehicular data unit. The authentication process is similar to the process in which a computer registers with a network router. The initial login is initiated using a default user password. Once the user begins the initial registration process, the system will require a new password, preventing theft or hijacking of the system at any point in the future. Once a new password is entered, this data, along with the cellular phone's unique identification number (the phone's MAC address and/or IMEI number and/or password) is encrypted and sent to the vehicular data unit. This unique identifying signature is stored in the vehicle's non-volatile memory, ensuring that the signature is not lost due to power failures or dead batteries. After the initial setup, any time a keyed phone is within range, the identifying signature is transferred to the vehicular data unit. This, in turn, causes the particular phone to come under the policies of the application once the vehicular ignition command is given from the phone. When the command to shut off the automobile is given from the driver's cellular phone, the cellular application provides the user with full cellular functionality.

In the case where the vehicle data unit has been acknowledged by a cellular phone and the user has initiated the starting of the car, the software application on the phone may conduct some action restricting access to some of the functionality of the phone. The access restrictions may be configured to comply with the driver's personal preferences or may be configured to comply with local laws. The options for restricted operation of the cellular phone may include, but are not limited to, the following actions. The safest and most secure restriction would be total disablement of cellular communication from the driver's phone. Less restrictive would be the option to disable the receiving or transmitting of electronic mail (e-mail) and text messages. A third possibility would be to enable the phone to only communicate in a “hands free” mode, which may include the capability to transmit and receive text messages and e-mail by voice. Another access restriction possibility would be to have the cellular phone automatically respond to all incoming text messages with a default message. These are a few configurations that could be used and configured to each individual driver's preference. Alternatively, the cellular phone system could query a location-based database with information pertaining to local cellular phone use laws. If said mode was selected, the phone would use internal location information provided by the on-board global positioning system (GPS) and transmit the data to the cloud-based database. The database would return the specific location based details to the phone and the settings would be autonomously implemented to ensure compliance with all local laws.

The system described in the preferred embodiment of the present invention is simple to use. Upon nearing the vehicle, a registered phone can be used to unlock the door(s) of the vehicle. The unlocking of the door(s) does not activate or engage the restricted use mode of the phone. Only upon the ignition command being issued via the phone does the phone become designated as the driver's phone.

Depending on the user preferences, the driver's phone may still have full functionality until the vehicle data unit begins to transmit velocity data. Once the phone confirms that the vehicle is in motion, the desired restrictions will be enacted, limiting the phone's functionality. At any time during travel that the velocity of the automobile is zero, the phone may resume full functionality. Upon completion of travel, the phone will issue the command to shut off the vehicle, which, in turn, will signal to the phone that full functionality should be restored, ushering the phone back into “standby” mode.

In the event that the cellular phone loses power, the vehicular data unit does allow for the driver to manually start or stop the vehicle's engine. The cellular phone would become unregistered, and manual operation policies would come under effect. Should the cellular phone regain power, the software application would re-connect with the vehicular data unit, allowing for the restrictions and limitations to be implemented based on the pre-determined preferences.

In an alternative embodiment, a driver may use a physical key to gain access to the automobile and to start the engine (manual operation). In this scenario, all phones within range of the vehicular data unit that have been keyed to the vehicle would automatically initialize the software application and apply the predetermined policies. In order to allow for only the driver's phone to be restricted in such a scenario, a process could be undertaken to designate the driver's phone as the “start command” initiator, allowing the other phones to function normally. If only a single person was in the vehicle then the restricted policy would be applied in either case. It could be assumed that if multiple people were occupying the vehicle that the passengers would not want the driver using the phone improperly. Also, a passenger would not want their phone usage to be restricted. Shutting off the vehicle manually (physical key) would cause the application to recognize the engine has stopped running and place the phones back into “standby” mode whether the vehicle was started manually or via the application.

The disclosed embodiment provides many benefits over presently available solutions. Because the system cannot be overridden, it creates a safer driving environment. Automobile insurance companies should offer discounts based on the installation and usage of the present invention, given the decreased probability of an automotive mishap. Another benefit of the present invention is that the data log provides an evidence trail of legal phone usage that can be used in disputing citation or accident claims. Additionally, the requirement to carry a physical key is no longer necessary, as the functionality of the key is entirely contained within the keyed cellular phone.

What is claimed:

1. A system for restricting access to a mobile cellular device comprising:
A vehicular data unit permanently affixed to an automobile with means of wireless communication, capable of transmitting vehicular velocity data, and capable of receiving commands for a variety of automobile functions;
A proprietary software application installed on said mobile cellular device allowing the cellular device to communicate with said vehicular data unit, capable of receiving data from vehicular data unit and exerting control over cellular device functionality based on data values.

2. The system as set forth in claim 1, in which the vehicular data unit further has the capability to communicate with multiple cellular devices simultaneously.

3. The system as set forth in claim 1, in which the vehicular data unit has the capability of initiating and verifying completion of automotive tasks comprising:
Starting and stopping of the automobile's engine;
Locking and unlocking of the automobile's doors;
Opening of the automobile's trunk;
Opening and closing of the automobile's windows and sunroof.

4. The system as set forth in claim 1 in which said software application operates continuously while cellular device is in a “powered-on” state comprising:
The ability to operate in a standby mode until a vehicular data unit is recognized;
The ability to securely transmit and receive authentication credentials to verify authorization to communicate with vehicular data unit;
The ability to transmit commands for automotive tasks;
The ability to receive confirmation of completion of automotive tasks;
The ability to restrict functionality of cellular phone based upon transmitted automotive task commands;
The ability to restrict functionality of cellular phone based upon combination of transmitted automotive task commands and vehicular motion data received from vehicular data unit.

5. The system as set forth in claim 1, which restricts access to cellular device functionality based upon designation as the driver of the automobile as determined by transmission of command to start the automobile engine from the cellular device and termination of functional restriction based upon transmission of a command to stop the automobile engine.

6. The system as set forth in claim 1, which restricts mobile device functionality based on local regulations comprising:
A method for the mobile device to determine geographic location;
The mobile device sending said location to a remote database containing geographic mobile device restriction information;
The mobile device implementing restrictions on device functionality based upon said database values.

7. The system as set forth in claim 2, which in the presence of a physical ignition key and physical engine ignition, will restrict cellular device functionality on all mobile devices communicating with vehicular data unit, unless a cellular device is designated as the automobile driver's device.
